(19) United States
(12) Patent Application Publication
(10) Pub. No.: US 2007/0173555 A1
(43) Pub. Date: Jul. 26, 2007

(54) ARTIFICIAL FLOWER OF POLYETHER POLYURETHANE AND METHOD OF ITS FABRICATION

(75) Inventor: Ka-Lok Loo, Hong Kong (CN)

Correspondence Address: EVAN LAW GROUP LLC, 600 WEST JACKSON BLVD., SUITE 625, CHICAGO, IL, 60661, US

(73) Assignee: SHEBO CHINA LIMITED, Hong Kong (CN)

(21) Appl. No.: 11/614,087

(22) Filed: Dec. 21, 2006

(30) Foreign Application Priority Data
Jan. 25, 2006 (CN) 200610033313.2
Aug. 9, 2006 (CN) PCT/CN06/02009
Nov. 10, 2006 (CN) PCT/CN06/03022

(51) Int. Cl. C08G 18/48

(52) U.S. Cl. 521/131

(57) ABSTRACT

Artificial flowers made of polyether polyurethane and the method of their production. The ingredients of the polyether polyurethane foam product are: Group A: 10%˜99.5% polyether, 0.5%˜30% cross-linking agent, 0%˜15% stabilizer, 0.1%˜20% foaming agent, 0%˜10% color paste; Group B: isocyanate in an amount equal to 15%˜90% of the total weight of Group A ingredients. By mixing group A and group B ingredients and pouring the mixture into the cavity of a flower mold, an artificial flower of polyether polyurethane foam is produced, which has a natural look and feel resemble the real flower, resists to damages caused by squeezes and collisions, and is stable at the high temperatures of the summer time.

### CROSS REFERENCE TO RELATED APPLICATION

This application claims priority to Chinese Patent Application No. 200610033313.2 filed Jan. 25, 2006, PCT Application No. PCT/CN2006/002009 filed Aug. 9, 2006 and PCT Application No. PCT/CN2006/003022 filed Nov. 10, 2006, the contents of which are hereby incorporated by reference.

### FIELD OF THE INVENTION

The present invention relates to an artificial flower. Particularly, it relates to an artificial flower fabricated with a foam-generating material of polyether polyurethane, and to the method of fabricating such an artificial flower.

### BACKGROUND OF THE INVENTION

Artificial flowers are popular household goods and occupy a large market in the world. They are commonly used as gift or interior decorating items. At the present time, artificial flowers are generally produced with plastic or cotton materials, and they do not look and feel nature. Plastic used as materials for making artificial flowers is unsatisfactory, unable to display vivid colors and give rise to the type of soft moisture feel as a real flower does. Further, the flowers may easily get deformed or damaged during transit, storage and usage process. Once deformed, such artificial flowers may not return to their original shape, i.e., they do not have memory for shapes. Recycling of the used flowers made with plastics materials, such as polyethylene (PE) pose problems for the environment. Lastly, PE-made artificial flowers may deform easily when exposed to the high temperature in the summer time. On the other hand, cotton-made flowers, in addition to sharing the problem of unnatural look and feel as the plastic flowers, tend to lose their color and luster easily and quickly. Therefore, there is long-felt need for solving the above-mentioned problems to meet the demand of the ever expanding market for artificial flowers.

### SUMMARY OF THE INVENTION

Accordingly, as an object of the present invention, there is provided an artificial flower that is not fabricated with plastics or cotton, but with a polyether polyurethane foam, a polymer consisting of a chain of organic units joined by urethane links. A polyether polyurethane flower (or “PU flower”) offers a more natural look and feel, which sometimes can be mistaken as the real flower. Some PU flowers, as particular embodiments of the present invention, are characterized with an infrared spectrum profile shown in FIG. 2, FIG. 3 and FIG. 4. Their infrared spectrum profile comprises the following absorption peaks:

C—O—C: 1100˜1250 cm⁻¹;

N—H: 3200˜3330 cm⁻¹;

C═O: 1640˜1755 cm⁻¹;

C—N: 1506˜1566 cm⁻¹;

aryl group: 1570˜1610 cm⁻¹ and 650˜900 cm⁻¹;

C—H: 2800˜2990 cm⁻¹ and 1350˜1450 cm⁻¹.

In a particular embodiment of the invention, the flower is made of polyether polyurethane having an infrared spectrum profile comprising the following absorption peeks:

C—O—C: 1100˜1250 cm⁻¹;

N—H: 3313 cm⁻¹;

C═O: 1728 cm⁻¹;

C—O: 1228 cm⁻¹;

C—N: 1536 cm⁻¹.

It is contemplated, however, that the polyurethane foam material of PU flowers according to the present invention may show characteristics different from the above-described, which are provided as an illustration only. People skilled in the art would readily appreciate that the above-described infrared spectrum profile may be changed with addition of additives to polyurethane. Indeed, the present invention is applicable to any artificial flowers made of soft, elastic or flexible polyurethane foams formed with polyether polyols and isocyanate creating the urethane links therein. As used in this disclosure and the claims, the term “artificial flower” means an article comprising one or more man-made object(s) resembling a flower petal or a leaf of a plant.

As another object of the present invention, there is provided an artificial flower that is made of a material formed by mixing two groups of ingredients, Group A and Group B, wherein: Group A comprises 10%-99.5% polyether, 0.5%-30% cross-linking agent, 0%-15% stabilizer, 0%-20% catalysts, 0%-30% water, 0.1%-20% foaming agent, and 0%-10% color paste. Group B comprises 15%-90% isocyanate. The amount of the ingredient in group B is expressed as weight percentage of the total weight of group A ingredients.

As another object of the present invention, there is provided a method of make an artificial flower of a polyether polyurethane material, which comprises a step of mixing two groups of ingredients: Group A and Group B. Group A comprises 10%-99.5% polyether, 0.5%-30% crosslinking agent, 0%-15% stabilizer, 0%-20% catalysts, 0%-30% water, 0.1%-20% foaming agent, and 0%-10% color paste. Group B comprises 15%-90% isocyanate; the weight percentage of the ingredients of group B is calculated based on the total weight of group A ingredients.

A preferred formulation for making flower petal is as follows: Group A comprises 70%-98.5% polyether, 0.5%-15% cross-linking agent, 0.1%-10% stabilizer, 0.1%-10% catalysts, 0.5%-15% water, 0.1%-10% foaming agent, and 0.1%-5% color paste. Group B comprises 15%-50% isocyanate; the weight percentage of the ingredients of group B is calculated based on the total weight of group A ingredients.

A preferred formulation for making flower stem is as follows: Group A comprises 10%-78.5% polyether, 20%-40% grafted polyether, 0.5%-15% cross-linking agent, 0.1%-10% stabilizer, 0.1%-10% catalysts, 0.5%-10% water, 0.1%-5% foaming agent, and 0.1%-5% color paste. Group B comprises 15%-65% isocyanate; the weight percentage of the ingredients of group B is calculated based on the total weight of group A ingredients.

For practicing the present invention, the chemicals used are described in the following: “polyether” means polyether polyols, a polymer whose main chain is made of a plurality of ether units (i.e., —R—O—R—) and having two or more hydroxyl groups (i.e. —OH) at the chain ends. Polyether polyols are well-known and commonly used to make polyurethane foams in various industries. The exemplary polyether suitable for practicing the present invention is polyoxypropylene glycol or polyoxypropylene triol. EP-330N, readily available commercially, is an example of polyether polyols that was used in the examples described below (one of the EP-330N vendors is Third Petrochemical Fadctory, 12 DengZhongLu, DongLi District, Tianjin, China (as TEP-330N); another one is Sinopec Shanghai Gaoqiao Petrochemical Corporation, 3000 Pudong Ave, Shanghai, China (as GEP-330N)).

“grafted polyether” means modified polyether polyols. TPOP 36-28, readily available commercially, is an example of grafted polyether that can be used in practicing the present invention (grafted polyether is available from the same venders of EP-330 mentioned above). It is a modified polyether formed by grafting PPG with propylene nitrile and styrene. It can mix with various PPG to make high resilient (HR) foam, semi-rigid foam, integral skin foam (ISF), etc, can foam in formulations designed for different hardness, and has low viscosity for easy processing. Typical quality control standards: hydroxyl value=25-29 mgKOH/g; water content≦0.05%; pH=6-9; viscosity≦3500 mpa·s/25° C.

“isocyanate” in this application means diisocyanate, a well-known precursor used to produce polyurethane. Preferred diisocyanate in the present invention is 1-isocyanato-4-(4-isocyanatobenzyl) benzene or methylene diphenyl diisocyanate (abbreviated as MDI), which is an aromatic diisocyanate, existing in three isomers, 2,2′-MDI, 2,4′-MDI, and 4,4′-MDI. An exemplary isocyanate used in the examples described below is MDI-50, which is commercially available (one of the vendors is Yantai Wanhua Polyurethanes Co., Ltd., No2, Xingfu South Road, Yantai, Shandong, China 264002. Tel: 0086 535 6856091, Fax: 0086 535 6837119 2). IMDI-50 comprises approximately 50% by weight the 4,4′-isomer and approximately 50% by weight the 2,4′-isomer. It is a colorless or slightly yellowish transparent liquid at room temperature. Typical quality control standards: chromaticity≦30 APHA; purity≧99.5%; NCO content≧33.3%; cyclo-cetane insoluble≦0.3%; hydrolyzed chlorine≦0.01%; density at 25° C.=1.19 g/cm³.

“autoskinning isocyanate” or “skinning type isocyanate” means any isocyanate which can facilitate skinning on foam material's surfaces. People with ordinary skill in the art are capable of selecting a suitable isocyanate for its autoskinning effect. The autoskinning isocyanate used in the examples described below typically satisfies the following quality standards: molecular weight equal to or greater than 250; fictionalization degree equal to or greater than 2.1; and NCO content equal to or greater than 29. Huntsman's product “5005” was an autoskinning isocyanate used in the examples described below (one of the vendors is Honk Polymer Co., Ltd, LongChi Development Zone, Zhangzhou, F J, PRC).

“high-resilient type isocyanate” means any isocyanate which can provide high resiliency to the resulting foam material. People with ordinary skill in the art are capable of selecting a suitable isocyanate for its high-resilient effect. BASF's product “MM-103C” was a high-resilient type isocyanate used in the examples described below (one of the vendors is Shanghai Annel Chemical.Technology Co.Ltd, Hecheng Business Tower No.36 Caobao Road, Xuhui District, Shanghai, China).

“cross-linking agent” means any chemicals which can cause cross-linking during polymerization in forming polyether polyurethane. People with ordinary skill in the art are capable of selecting a suitable cross-linking agent to form polyether polyurethane for a particular purpose. In general, the cross-linking agent plays a catalytic function during formation of polyether polyurethane, not only by increasing the speed of the underlying chemical reaction but also ensuring completion of the reaction. The cross-linking agent used in the examples described below is triethanolamine, diethanolamine, or combination of the two chemicals.

“stabilizer” means silicone foam surfactant optionally used to facilitate the chemical reaction during polymerization by increasing solubility of reactants in each other, helping bubble formation and stabilizing the bubbles. It can be used to adjust elasticity and texture of the resulting polyether polyurethane foam. The stabilizer used in the examples described below is Product No. Y-10366, from Foshan Lison Chemicals Co., Ltd, 38 Fenjiang Nan Road, Chancheng District, Foshan, Guangdong, China.

“foaming agent” means a volatile chemical, also referred to as “blowing agent,” added to the reaction mixture of polymerization in polyurethane production. Foaming agents can be simple volatile chemicals such as acetone or methylene chloride, or more sophisticated fluorocarbons for particular performance characteristics. People with ordinary skill in the art are capable of selecting a suitable foaming agent to form polyether polyurethane for a particular purpose. The foaming agent used in the examples described below were dichloromethane (methylene chloride), dichlorofluoroethane (1,1-dichloro-1-fluoroethane), or a mixture of the two chemicals.

The catalysts used in the examples described below were triethylenediamine (1,4-diazabicyclo(2,2,2)octane), bis(2-dimethylaminoethyl)ether (2,2′-oxybis(N,N,-dimethylethylamine), or a mixture of the two chemicals. These are preferred catalysts but people with ordinary skill in the art may use other catalysts which may also produce satisfactory results. Furthermore, people with ordinary skill in the art are capable of choosing a suitable color paste for commercial sources (which may be dye-based or pigment-based) to optionally used in practicing the present invention to ensure a suitable color appearance of the resulting polyether polyurethane flower. Preferable, the color paste should be water soluble.

The quality control standards described above for the particular exemplary chemicals used in the examples are not limitations to the present invention. They are listed for the purpose of providing a full description of the materials used in the particular embodiments.

The various features of novelty which characterize the invention are pointed out with particularity in the claims annexed to and forming a part of this disclosure. For a better understanding of the invention, its operating advantages, and specific objects attained by its use, reference should be made to the drawings and the following description in which there are illustrated and described preferred embodiments of the invention.

### BRIEF DESCRIPTION OF DRAWINGS

FIG. 1 shows the results of a thermogravimetric analysis of the flower materials of the present invention.

FIG. 2 is infrared spectra of the white flower material as disclosed in example 1.

FIG. 3 is infrared spectra of the light-yellow flower material as disclosed in example 2.

FIG. 4 is infrared spectra of the red flower material as disclosed in example 3.

### DETAILED DESCRIPTION OF PARTICULAR EMBODIMENTS

The essence of the present invention is the use of polyurethane as the material for fabricating artificial flowers and to applicants' knowledge polyurethane had never been used as the main material for artificial flowers.

The primary polyurethane producing reaction is between a diisocyanate (either aromatic or aliphatic types) and a polyol, typically a polyethylene glycol or polyester polyol, in the presence of catalysts and additives for controlling the cell structure. For example surfactants may be used as an additive in the case of foams. Polyurethane can be made in a variety of densities and hardness by varying the type of monomer(s) used and adding certain additives to modify their characteristics, notably density, or enhance their performance. Other additives can be used to improve the fire performance, stability in difficult chemical environments and other properties of the polyurethane products. As relevant knowledge and various techniques in polyurethane production are well known in the art, the following disclosure focuses on the particular examples of formulating polyurethane production for illustrating the practice of the present invention. It is contemplated that polyurethane produced with some other specific formulations may also be suitable for fabricating artificial flower of the present invention.

### EXAMPLE 1

### Flower of White Lily (Including its Stem)

### Composition:

As one particular embodiment of the present invention, a white lily flower was made according to the following description:

Ingredients for the making of the flower petals comprise group A and group B. Group A comprises: 80% polyether, 3% cross-linking agent, 2% stabilizer, 1.5% catalyst, 4% water, 4.2% foaming agent and 1.3% color paste. Group B comprises: 18% skinning-type isocyanate, 36% high resilient-type isocyanate, wherein the weight percentage of the ingredient in group B is calculated based on the total weight of group A. In this particular example, the ingredients of group A in producing an artificial lily have a weight of 20 kg. In group B, the weight of the skinning-type isocyanate is 3.6 kg while the weight of the high resilient-type isocyanate is 7.2 kg.

Ingredients for making the flower stem also comprise group A and group B: Group A comprises: 50% polyether, 25% grafted polyether, 5% cross-linking agent, 3% stabilizer, 6% catalyst, 4% water, 3% foaming agent, 4% color paste. Group B comprises: 40% skinning-type isocyanate, 20% high resilient-type isocyanate, wherein the weight percentage of the ingredient in group B is calculated based on the total weight of group A, as illustrated above.

The polyether used was EP-330N.

The grafted polyether was POP 36-28.

The skinning-type isocyanate was 5005 made by Huntsman.

The resilient-type isocyanate was MM-103C made by BASF.

The stabilizer used was Y-10366 made by GE.

The color paste used was made by Perfectchem (http://www.perfectchem.com E-mail:webmaster perfectchem.com).

The cross-linking agent used was: 50% triethanolamine and 50% diethanolamine.

The catalyst used was: triethylenediamine.

The foaming agent used was 30% methylene chloride and 70% dichlorofluoroethane.

### Fabrication Process:

All of the above-listed ingredients, except the color paste, were put into a container and stirred for one to two hours to mix the ingredients well. The mold of a lily flower was placed inside an oven and heated for about 60 minutes. The temperature should be maintained at 50° C. Once reaching the desired temperature, the mold was sprayed with a mold shedding agent and optionally some color paint (made from a chosen color paste) on the internal surfaces and assembled on a molding machine. The well mixed ingredients were poured or injected into the inner space or cavity of the mold to form the flower shape by using a PU injecting instrument. The mold was heated to 130C and maintained the temperature for about 3-10 minutes. The mold was then opened and the formed lily shape replica was taken out. Finally, a white color paste is sprayed onto the flower head and stem surface, which then undergoes dry heat to fix its shape, whereby an artificial white lily flower is produced. As the texture and suppleness of the flower petals are very similar to real flowers, the artificial lily looks and feels just like a real one. In comparison with the artificial silk flowers available in current markets, the flower replica of the present invention is four times as supple and does not easily get broken by folding. Further, the luster and vivid color give a realistic effect to the artificial flower.

### EXAMPLE 2

### Light-Yellow Artificial Flower

### Composition:

Group A comprises: 70% polyether, 6% cross-linking agent, 4% stabilizer, 0.5% catalyst, 14% water, 4.2% foaming agent and 1.3% color paste.

Group B comprises: 10% skinning-type isocyanate, 45% resilient-type isocyanate, wherein the weight percentage of the ingredient in group B is calculated based on the total weight of group A.

The specific compounds used are the same as used in Example 1. The fabricating process is the same as described in Example 1. A yellow color paste was used, however, and was mixed with Group A ingredients.

### EXAMPLE 3

### Red PU Artificial Flower

### Composition:

Group A comprises: 90% polyether, 2% cross-linking agent, 3% stabilizer, 1% catalyst, 2% water, 1.2% foaming agent and 0.8% color paste.

Group B comprises: 60% skinning-type isocyanate, wherein the weight percentage of the ingredient in group B is calculated based on the total weight of group A.

The specific compounds used are the same as used in Example 1. The fabricating process is the same as described in Example 1. A red color paste was used, however, and was mixed with Group A ingredients.

### EXAMPLE 4

### Another Artificial Flower Variant

The same process as described in Example 1 was used but with a different formulation. For the flower head: Group A comprises 70% polyether, 5% crosslinking agent, 3% stabilizer, 3% catalyst, 7% water, 9% foaming agent and 3% color paste. Group B comprises 15% skinning-type isocyanate and 25% resilient-type isocyanate; wherein the weight percentage of the ingredient in group B is calculated based on the total weight of group A.

For the flower stem: Group A comprises 50% polyether, 25% grafted polyether, 5% crosslinking agent, 3% stabilizer, 6% catalyst, 4% water, 3% foaming agent and 4% color paste. Group B comprises 40% skinning-type isocyanate and 20% resilient-type isocyanate, wherein the weight percentage of the ingredient in group B is calculated based on the total weight of group A.

The specific compounds used are the same as used in Example 1. The fabricating process is the same as described in Example 1.

### EXAMPLE 5

### Another Artificial Flower Variant

The same process as described in Example 1 was used but with a different formulation. For the flower head: Group A comprises 60% polyether, 8% crosslinking agent, 2% stabilizer, 1.5% catalyst, 8.5% water, 15% foaming agent and 5% color paste. Group B comprises 50% resilient-type isocyanate, wherein the weight percentage of the ingredient in group B is calculated based on the total weight of group A.

For the flower stem: Group A comprises 78.5% polyether, 8% cross-linking agent, 0.1% stabilizer, 1.4% catalyst, 8.5% water, 2% foaming agent and 1.5% color paste. Group B comprises 45% skinning, wherein the weight percentage of the ingredient in group B is calculated based on the total weight of group A.

The specific compounds used are the same as used in Example 1. The fabricating process is the same as described in Example 1.

Three samples of flowers made in Examples 1-3, i.e., white lily, light yellow flower and red flowers, were tested by following methods pursuant to the U.S. Materials and Testing Association:

### Properties of the Artificial Flower Fabricated According to the Present Invention

To demonstrate the different properties of the artificial flowers of the present invention as compared to the prior art flowers, the samples fabricated according to Examples 1, 2 and 3 were subject to the following testing:

### (1) Qualitative Analysis of the Ingredient:

| | |
|---|---|
| Tested Samples | White flower of Example 1; Light-Yellow flower |
| | of Example 2; and Red flower of Example 3. |
| Testing Environment | Temperature (T): 23 ± 3° C.; Relative humidity |
| | (RH): 50 ± 5% |
| Testing Purpose | Infrared qualitative determination of the |
| | ingredient |
| Testing Method | ASTM E 1252-98, Standard practice for general |
| | techiniques for obtaining infrared spectra for |
| | qualitative analysis. |
| Testing Instrument | NICOLET Magna-IR 550 spectrometer and |
| | Nic-Plan ™ IR Microscope |

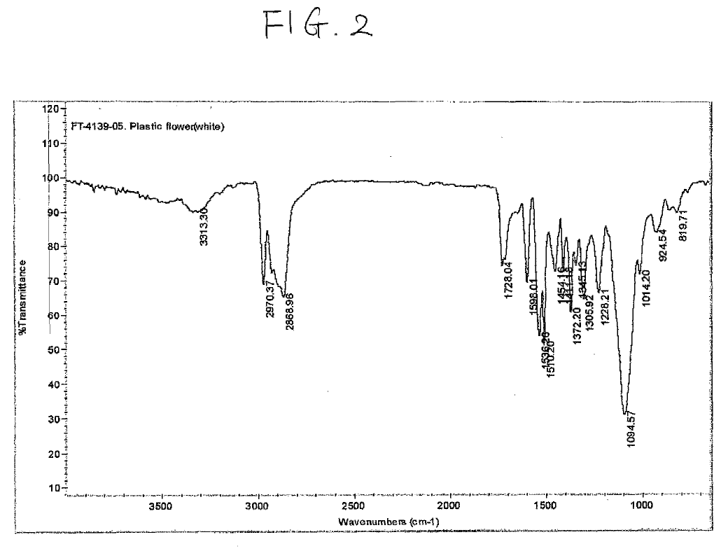

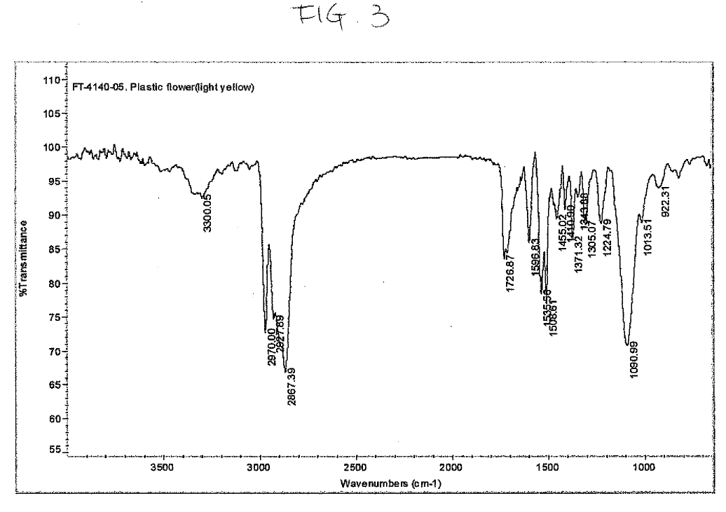

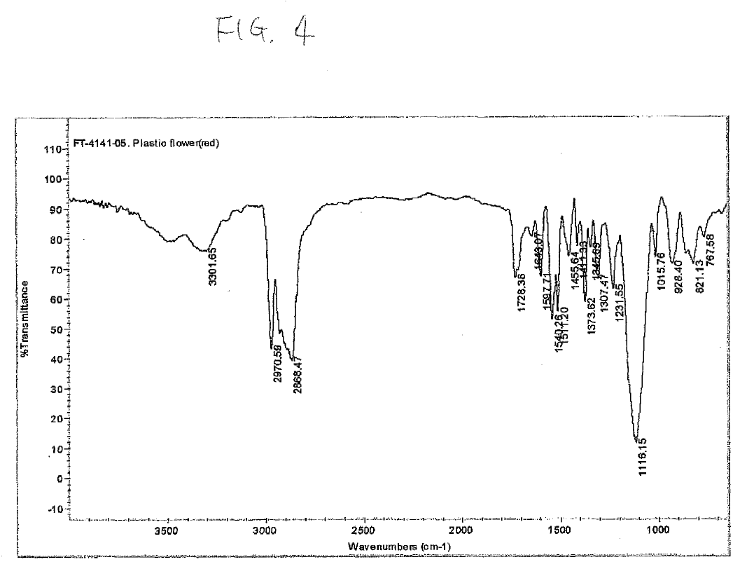

The following is the testing results (the infrared spectra are presented in FIGS. 2, 3, and 4):

| Sample name | Spectra code | Qualitative determination |
|---|---|---|
| White flower | FT-4139-05 | Polyether polyurethane |
| Light yellow flower | FT-4140-05 | Polyether polyurethane |
| Red flower | FT-4141-05 | Polyether polyurethane |

The infrared spectra FT-4139-05 shows the following characteristic absorption peaks: —N—H: 3313 cm⁻¹; C═O: 1728 cm⁻¹; —C—O—: 1094, 1228, 1014 cm¹; —C—N—: 1536 cm⁻¹; —CH/CH₂/CH₃: 2970, 2928, 2868, 1411, 1372 cm⁻¹; aromatic benzene ring structure: 1598, 1510, 1454, 819 cm⁻¹. The results thus confirm that the artificial flowers of the present invention are polyurethane-based.

### (2) Measurement of Hardness:

A standard instrument for measuring hardness of plastics was used (ASTM D2240-05 Standard Test Method for Rubber Property—Durometer Hardness, using PTC Durometer Digital Model 511A ASTM Type A as testing equipment). The testing results are shown in the following:

| Sample | Hardness (A) |
|---|---|
| White flower | 39 |
| Light yellowish flower | 46 |
| Red flower | 31 |

As shown above, the hardness of artificial flowers fabricated according to the present invention is much lower than those made by PE materials currently available in the market. This property help to reduce the fragility of artificial flowers.

### (3) Measurement of Elasticity

A standard instrument for measuring elasticity of plastics was used. The testing results are as follows:

| | Anti-stretch strength | | Maximum-strain | |
|---|---|---|---|---|
| | (N) | | (%) | |
| Sample | longitude | latitude | longitude | latitude |
| White flower | 30.62 | 35.45 | 73.42 | 105.31 |
| Light yellow flower | 25.90 | 17.88 | 100.75 | 79.17 |
| Red flower | 5.80 | 4.98 | 75.52 | 64.99 |

As shown above, Anti-stretch strength and Maximum-strain of the artificial flowers of the present invention are higher than artificial flowers made of plastic or cotton materials, which allow the elasticity/softness and texture (touch feel) to be very similar to real flowers. After subjected to squeeze, collision or other external forces, the artificial flowers of the present invention can return to the initial shape without being permanently deformed.

### (4) Measurement of Thermal Stability

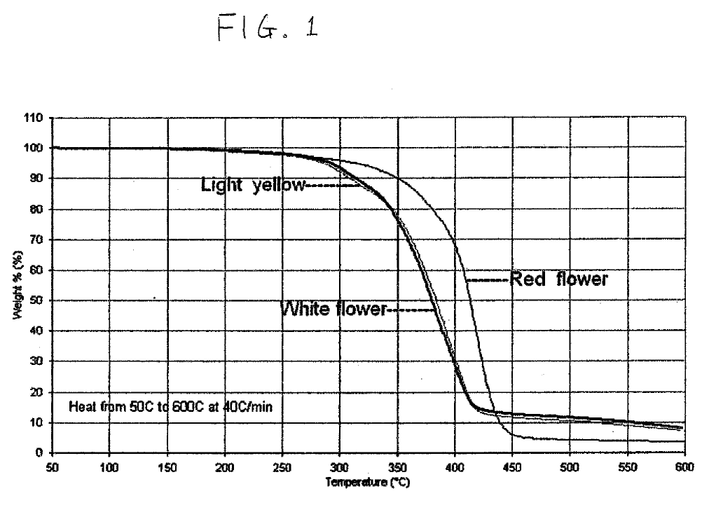

The flower samples undergo thermogravimetric analysis at an increasing temperature (40° C./minute) up to 600° C. The testing results are shown in FIG. 1 and as follows:

| Sample | Degradation Temperature (° C.) |
|---|---|
| White flower | 333.44 |
| Light yellowish flower | 340.59 |
| Red flower | 388.10 |

As shown in FIG. 1, when the artificial flowers of the present invention exposed to temperature at 250° C. or below, the materials withstood the heat and showed no signs of degradation. Only when the temperature went higher than 300° C., did the materials start heat degradation. When the temperature increased to about 350° C., the materials rapidly degraded into small molecules and lose weight. The results demonstrate that the flower of the present invention has sufficient thermal stability for everyday use under normal conditions and would not melt or deform even under high temperatures in the summer time.

The above testing demonstrates that the artificial flower made of polyether polyurethane according to the present invention stands in sharp contrast with conventional artificial flowers (which are usually made of plastic materials, with undesirable hardness and lack of elasticity/softness, can be easily damaged, and look dull without natural luster and vividness of real flowers). The flowers (petals or leaves) of the present invention, on the other hand, look and feel very similar to real flowers and retain the memory of its initial shape after subjected to external forces such as squeezing and pressing. The flower petals and plant leaves can be made showing vein-like lines, through which a supporting wire can be optionally embedded. In addition, as the flower stem can be made using skinning-type (auto-skinning) isocyanate, its surface is slightly harder than the internal material, just like a real flower stem.

The flower petals according to the present invention can be made with a thickness of only 0.5 mm, having an effect of being “as thin as the wing of a fly.” Even with such a thickness, the flower can still maintain its shape. The practitioner of the present invention can make various kinds of flowers based on individual taste and preference, using them as articles of decoration and ornament, thereby bringing pleasure and adding joyfulness to people's life. For example, a flower-shaped ornament made of polyurethane according to the present invention may be placed or fixed on a woman's cloth or on her hair, to name just a few. As defined previously, the term “artificial flower” refers to an article that comprises one or more man-made object(s) resembling a plant leaf or flower petal, where the leaf or petal can be of various color.

Furthermore, as a flower material, polyurethane is stable and does not change easily. A variety of additives, for example, such as scent, fragrance and flame retardant can be conveniently added to the formulation. The additives can have long-lasting effects within polyurethane.

While there have been described and pointed out fundamental novel features of the invention as applied to a preferred embodiment thereof, it will be understood that various omissions and substitutions and changes, in the form and details of the embodiments illustrated, may be made by those skilled in the art without departing from the spirit of the invention. The invention is not limited by the embodiments described above which are presented as examples only but can be modified in various ways within the scope of protection defined by the appended patent claims.

What is claimed is:

1. An artificial flower comprising at least one part resembling a flower petal or a leaf of a plant, at least 50% by weight of said part being polyurethane foam.

2. The artificial flower of claim 1, wherein at least 70% by weight of said part is polyurethane foam.

3. The artificial flower of claim 2, wherein at least 90% by weight of said part is polyurethane foam.

4. The artificial flower of claim 1, wherein said polyurethane foam is formed through a reaction between reactants comprising a diisocyanate and a polyol in the presence of one or more catalysts, said diisocyanate being aromatic or aliphatic and said polyol being a polyether polyol.

5. The artificial flower of claim 4, wherein said reactants comprise a skinning-type diisocyanate, a high-resilient type diisocyanate, or both a skinning-type diisocyanate and a high-resilient type diisocyanate.

6. The artificial flower of claim 4, wherein said diisocyanate is MDI-50, and said polyether polyol is polyoxypropylene glycol or polyoxypropylene triol.

7. The artificial flower of claim 4, wherein said catalyst is triethylenediamine or bis(2-dimethylaminoethyl)ether.

8. The artificial flower of claim 4, wherein said reaction is in further presence of one or more foaming agents.

9. The artificial flower of claim 8, wherein said foaming agent is dichloromethane, dichlorofluoroethane, water, or a mixture thereof.

10. The artificial flower of claim 4, wherein said reaction is in further presence of one or more cross-linking agents.

11. The artificial flower of claim 10, wherein said cross-linking agent is triethanolamine or diethanolamine.

12. The artificial flower of claim 4, wherein said reaction is in further presence of one or more stabilizer.

13. The artificial flower of claim 12, wherein said stabilizer is silicone foam surfactant.

14. The artificial flower of claim 1, wherein said part has an infrared spectrum profile comprising the following absorption peaks:
1100-1250 cm⁻¹;
3200-3330 cm⁻¹;
1640-1755 cm⁻¹;
1506-1566 cm⁻¹;
1570-1610 cm⁻¹;
650-900 cm⁻¹;
2800-2990 cm⁻¹; and
1350-1450 cm⁻¹.

15. The artificial flower of claim 14, wherein said part has an infrared spectrum profile comprising the following absorption peaks:
1100-1250 cm⁻¹;
3313 cm⁻¹;
1728 cm⁻¹;
1228 cm⁻¹; and
1536 cm¹.

16. A method for fabricating said part of the artificial flower of claim 1, comprising the steps of: (a) mixing Group A and Group B of ingredients to obtain a mixture, wherein Group A comprises 10%˜99.5% polyether, 0.5%˜30% cross-linking agent, 0%-15% stabilizer, 0%-20% catalysts, 0%˜30% water, 0.1%˜20% foaming agent, and 0%˜10% color paste and Group B comprises 15%˜90% isocyanate; the weight percentage of the ingredient of Group B being calculated based on the total weight of Group A ingredients; (b) placing a mold with a cavity inside an oven maintaining it at a desired temperature; and (c) filling said cavity of said mold with said mixture; and (d) heating said mold to a temperature sufficient for starting and completing polymerization to form polyurethane foam.

17. The method of claim 16, wherein Group A further comprises grafted polyether which accounts 20%-40% of total weight of Group A.

18. The method of claim 17, wherein said polyether accounts for 10%-75% of total weight of Group A; said cross-linking accounts for 0.5%-15% of total weight of Group A; said stabilizer accounts for 0.1%-10% of total weight of Group A; said catalyst accounts for 0.1%-10% of total weight of Group A; said water accounts for 0.5%-10% of total weight of Group A; said foaming agent accounts for 0.1%-5% of total weight of Group A; and said color paste accounts for 0.1%-5% of total weight of Group A.

19. The method of claim 16, wherein said polyether is polyoxypropylene glycol or polyoxypropylene triol.

20. The method of claim 16, wherein said isocyanate is MDI-50.

21. The method of claim 16, wherein said catalyst is triethylenediamine or bis(2-dimethylaminoethyl)ether.

22. The method of claim 16, wherein said cross-linking agent is triethanolamine or diethanolamine.

23. The method of claim 16, wherein said foaming agent is dichloromethane, dichlorofluoroethane, or water, or a mixture thereof.

24. The method of claim 16, wherein said stabilizer is silicone foam surfactant.

25. The method of claim 16, wherein said temperature in step (d) is 120-140° C.
